(19) United States
(12) Patent Application Publication
(10) Pub. No.: US 2009/0295187 A1
(43) Pub. Date: Dec. 3, 2009

(54) Car door hinge

(76) Inventor: Demetrius Calvin Ham, Dingmans Ferry, PA (US)

Correspondence Address: Demetrius C. Ham, 10 Woodridge Court, Newton, NJ, 07860, US

(21) Appl. No.: 12/154,980

(22) Filed: May 29, 2008

(51) Int. Cl. B60J 9/00

(52) U.S. Cl. 296/146.11

(57) ABSTRACT

An improved vehicle door hinge allows a door to swing open in a horizontal plane in order to clear the vehicle frame, this rotation is accomplished by a hinge. A curved rail mounted on the door then allows the hinge portion to move upward, the curvature of the rail allowing a small amount of motion of the rail to cause a twist of the door as it moves, and the twist causes the door to move clear of the doorway of the vehicle frame. The rail comprises roller races on each edge, the rail races have running on them a set of four rollers, two rollers on each edge of the rail. The hinge is located on one end of the rail.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### CROSS-REFERENCE TO RELATED APPLICATIONS

N/A

### FIELD OF THE INVENTION

This invention relates generally to vehicles devices, and specifically to vehicle door hinge devices.

### STATEMENT REGARDING FEDERALLY FUNDED RESEARCH

This invention was not made under contract with an agency of the US Government, nor by any agency of the US Government.

### BACKGROUND OF THE INVENTION

Conventional door hinges on automobiles have a number of problems. As is well known, such conventional systems hinge the door at the front of the edge and swing the door outwards through a horizontal arc which brings the rear edge of the door quite distant from the vehicle body. A spring action which assists in the opening of the door attempts to push the door open to substantially the full distance it is capable of opening. Opening the door in this fashion results in either the door's rear edge hitting whatever the vehicle is stopped next to or else requires the user to “fight” the door continuously as they get out of the vehicle, to prevent the door from reaching the full extension outwards. Since vehicles quite often end up parked next to either another vehicle or an abrasive concrete surface, allowing the door to swing out and impact the object next to the vehicle is distinctly undesirable.

Even when the user is not forced to limit the door's motion to a safe degree (for example, when the vehicle is parallel parked or parked next to an empty parking spot), the door itself is usually partially in the way of the user. Typically, the door opens somewhat less than 90 degrees and has a substantial width and a fair number of projections such as interior door handles, knobs, window controls, etc. The result is that around one half of the available arc beside the vehicle is covered by the door, making entry and egress a bit more difficult. Occasionally, a user may be blocked from even reaching the vehicle's entryway by the body of the door, for example, when the door is already open and the user approaches the vehicle from the front. Either the door must be partially or wholly closed to allow the user to squeeze past, then reopened to allow entry, or the user must walk around the vehicle the other direction.

Given the omnipresence of traffic, such diversions from simple entry are dangerous to users, and when a vehicle is parallel parked, a projecting door on the driver's side of the vehicle becomes an obstacle and danger to traffic. The projecting door itself is also in danger of being struck and damaged by passing traffic.

One possible solution to the horizontally hinged door is the vertically hinged door. Certain expensive types of automobiles have frames custom designed to support vertically hinged doors. Such doors are hinged to swing straight upwards at opening, in an arc in one dimension. However, it is normally necessary to implement such doors at the time the vehicle frame is designed, so as to allow for a frame which does not impede the top of door when it moves vertically.

U.S. Pat. No. 6,845,547 (Jan. 25, 2005), U.S. Pat. No. 7,059,655 (Jun. 13, 2006), and U.S. Pat. No. 7,140,075 (Nov. 28, 2006), all in the name of the present inventor, Demetrius Calvin Ham, teach hinges which may be easily retrofitted to existing vehicles and which allow two plane rotational motion: the door opens first by swinging in a first plane and then opens further by swinging in a second plane, the first plane allowing the door to swing a limited distance horizontally and the second plane bringing the door vertically upward.

U.S. Pat. No. 2,777,728 issued Jan. 15, 1957 to Barenyi for MOTOR VEHICLE ACCESSIBLE BY MEANS OF A PIVOTAL CAP teaches a one dimensional hinge in which the entire cab of the vehicle rotates in one plane of motion.

U.S. Pat. No. 3,870,361 issued Mar. 11, 1975 to Krause for HINGED SYSTEM FOR AUTOMOBILE DOORS WITH HINGE HALVES WELDED TO BODY AND DOOR teaches a one dimensional hinge in which the vehicle door rotates in one plane of motion. This patent also teaches an eccentric bushing allowing adjustment of the door hinge to achieve a tight fit; details of the structure of the bushing are different from the present invention.

U.S. Pat. No. 4,238,876 issued Dec. 16, 1980 to Monroe et al for METHOD FOR CONVERTING HARD TOP VEHICLES TO REMOVABLE TOP VEHICLES teaches non-analogous devices for sealing a vehicle roof to a car body. No hinges are discussed. U.S. Pat. No. 4,684,167 issued Aug. 4, 1987 to Newmayer for ROOF HINGED DOOR APPARATUS teaches a one dimensional hinge allowing rotation of a vehicle door in one plane of motion. The hinge is located at the top of the door, not the front, and the form of rotation would necessarily involve a large and undesirable swing outwards away from the vehicle body, making opening the door impossible when parked close to another vehicle or other obstruction.

U.S. Pat. No. 5,013,082 issued May 7, 1991 to Landmesser for DOOR HINGING SYSTEM teaches a vertically opening door which moves in a single plane of motion on a substantial support arm located somewhere on the auto body.

U.S. Pat. No. 5,242,208 issued Sep. 7, 1993 to Ohya for STRUCTURE OF A BODY OF AN AUTOMOTIVE VEHICLE teaches not one but two single plane hinges which move a portion of the car door in a single plane vertically upwards and a second portion of the car door in a second single plane in the normal fashion.

U.S. Pat. No. 5,261,720 issued Nov. 16, 1993 to Lomax, Jr. et al for VERTICALLY MOVING CAR DOOR teaches a rear hatch which slides upwards in a single plane of motion, on rails.

U.S. Pat. No. 5,921,611 issued Jul. 13, 1999 to Townsend for UPWARDLY RETRACTING VEHICLE DOOR also teaches a rear hatch which rotates upwards in a single plane of motion, on rails.

U.S. Pat. No. 5,992,918 issued Nov. 20, 1999 to Gobart et al for BI-FOLD GULL WING VEHICLE DOOR teaches a design in which the vehicle door only rotates in one plane but actually folds up in the middle, that is, it has two sets of hinges, one set at the top of the door and one set in the middle of the door itself to provide the fold.

U.S. Pat. No. 7,347,483 issued Mar. 25, 2008 to De Bono teaches a device very similar to the Ham patents, using a bi-hinge devices rather than rails.

U.S. Pat. No. 7,328,932 issued to Plavetich et al on Feb. 12, 2008, teaches a device with rods and struts which is also not rail related.

U.S. Pat. No. 7,287,805 issued Oct. 30, 2008, to Yamada et al teaches a minivan sliding hatch design in which rails are used to provide forward and back motion of the door in a single plane of sliding motion.

US Patent Publication No. 2004/0256882 published Dec. 23, 2004 in the name of McRoberts teaches another hinge type device without rails.

U.S. Pat. No. 7,007,346 issued Mar. 7, 2006 to Hoffman, teaches a device with a different type of bi-hinge but no rails.

It would be preferable to provide a stronger mechanism than bi-hinge devices, which would allow easy retrofit to existing vehicles without any substantial modifications or with only trivial modifications to the frame or fenders of the vehicle.

It would further be preferable to provide a rail mechanism offering low cost manufacture and easy installation and adjustment in use.

### SUMMARY OF THE INVENTION

General Summary

The present invention teaches an improved vehicle door hinge which allows a vehicle door to swing open in a horizontal plane in order to clear the vehicle frame, this rotation is accomplished by a hinge. By means of this rotation, the vehicle door may clear the doorway of the frame without requiring any substantial modification of the frame of the vehicle.

A curved rail mounted on the door then allows the hinge portion to move upward, the curvature of the rail allowing a small amount of motion of the rail to cause a “twist” of the door as it moves, with the word “twist” being defined as rotation about a point not actually located on the door or the hinge: the axis (or multiple axes of rotation, depending on rail shape) of the rotation is rather located at a point in space several inches clear of the hinge, rail or door. This twist (rotation about a point off of the door) causes the door to move clear of the doorway of the vehicle frame; in particular, locating the axis of rotation off of the door means that a given angle of rotation causes a greater amount of physical motion of the door.

In addition, the physical structure of the device, the hinge and rail, allow the installation of the hinge device onto a vehicle frame and into a fender without substantial modification of the vehicle.

The rail comprises roller races on each edge, the rail races have running on them a set of rollers, one, two, three or more rollers on each edge of the rail. The rollers may be asymmetrical, with one roller on one side and two on the other and so on. The rollers are mounted on a support and the support is mounted on a chassis anchor plate which is mounted to the chassis/frame of the vehicle.

The hinge is located on one end of the rail, stops at the other end of the rail prevent motion of the rail out of the rollers.

### SUMMARY IN REFERENCE TO CLAIMS

It is therefore another aspect, advantage, objective and embodiment of the invention, in addition to those discussed previously, to provide a vehicle door hinge for a vehicle door and body, the hinge comprising:
an anchor plate secured to such vehicle, the anchor plate having a support thereon, the support having a first roller thereon;
a door plate secured to such vehicle door;
a hinge secured to such door plate, the hinge having a rail having a length projecting therefrom, thereby allowing the door plate to rotate in a first plane of motion relative to the rail;
the rail physically engaged to the first roller and the rail supported by the first roller.

It is therefore another aspect, advantage, objective and embodiment of the invention to provide a vehicle door hinge further comprising:
a first rail edge and a first roller race disposed along the length parallel to the first rail edge, the first roller engaged with the first rail edge and first roller race.

It is therefore another aspect, advantage, objective and embodiment of the invention to provide a vehicle door hinge further comprising:
a second rail edge and a second roller race disposed along the length parallel to the first rail edge;
a second roller on the support, the second roller physically engaged with the second rail edge and second roller race, thereby allowing mutual motion of the rail and rollers along the length and preventing mutual motion in any other dimension.

It is therefore another aspect, advantage, objective and embodiment of the invention to provide a vehicle door hinge further comprising:
a stop located at a first end of the rail, the stop terminating the roller race, thereby preventing relative motion of the rail and rollers beyond the first end of the rail.

It is therefore another aspect, advantage, objective and embodiment of the invention to provide a vehicle door hinge further comprising:
third and fourth rollers on the support, the third and fourth rollers physically engaged with the respective first and second rail edges and first and second roller races, thereby preventing angular motions of the rail relative to the support.

It is therefore another aspect, advantage, objective and embodiment of the invention to provide a vehicle door hinge wherein the support further comprises:
a first axle pin passing through an aperture in the roller and secured to the support, the roller mounted upon the support by means of the axle pin.

It is therefore another aspect, advantage, objective and embodiment of the invention to provide a vehicle door hinge wherein the support further comprises:
a roller stop mounted upon the first axle pin, the roller stop larger than the aperture thereby preventing the roller from leaving the axle pin.

It is therefore another aspect, advantage, objective and embodiment of the invention to provide a vehicle door hinge wherein the hinge further comprises:
upper and lower hinge arms having apertures therethrough;
a middle rail hinge arm on a second end of the rail, the middle rail hinge arm also having an aperture therethrough;
a hinge pin passing through the apertures in the upper, middle and lower arms.

It is therefore another aspect, advantage, objective and embodiment of the invention to provide a vehicle door hinge wherein the rail is curved.

It is therefore another aspect, advantage, objective and embodiment of the invention to provide a vehicle door hinge wherein the curvature of the rail causes rotation of the door when the roller and rail move relative to one another, the rotation occurring in a second plane of motion.

It is therefore yet another aspect, advantage, objective and embodiment of the invention to provide a vehicle door hinge wherein the curvature of the rail has a radius of curvature and wherein the radius of curvature is such that the axis of rotation of the door in the second plane of motion occurs about a point located outside of the vehicle, frame and door.

It is therefore another aspect, advantage, objective and embodiment of the invention to provide a vehicle door hinge wherein the support may be angled in reference to the anchor plate.

It is therefore another aspect, advantage, objective and embodiment of the invention to provide a vehicle door hinge wherein the rotation in the first plane of motion is greater than or equal to 90 degrees.

It is therefore another aspect, advantage, objective and embodiment of the invention to provide a method of opening a vehicle door in a vehicle door frame, the method comprising the steps of:
a) rotating the vehicle door in a horizontal plane of motion until the vehicle door substantially clears the vehicle frame;
b) raising the vehicle door in a vertical plane of motion defined by the mutual motion of a rail mounted on the vehicle door and at least one roller mounted on the vehicle frame.

It is therefore another aspect, advantage, objective and embodiment of the invention to provide a method of opening a vehicle door in a vehicle door frame, wherein the rail is curved.

It is therefore another aspect, advantage, objective and embodiment of the invention to provide a method of opening a vehicle door in a vehicle door frame, wherein the curvature of the rail causes rotation of the door when the roller and rail move relative to one another, the rotation occurring in a second plane of motion.

It is therefore another aspect, advantage, objective and embodiment of the invention to provide a method of opening a vehicle door in a vehicle door frame, wherein the curvature of the rail has a radius of curvature and wherein the radius of curvature is such that the axis of rotation of the door in the second plane of motion occurs about a point located outside of the vehicle, frame and door.

### BRIEF DESCRIPTION OF THE DRAWINGS

FIG. 1 is a partially transparent side view of a vehicle having the hinge of the invention installed thereon.

FIG. 2 is a side view of the hinge of the invention, in the position to maintain the vehicle door in the closed position.

FIG. 3 is an elevational perspective view of the hinge of the invention, in the position to maintain the vehicle door in the closed position.

FIG. 4 is an exploded view in elevation and perspective of the parts of the invention.

FIG. 5 is an elevational perspective view of the hinge of the invention, in the position achieved when the vehicle door is swinging/swung open horizontally but not yet rolling vertically.

FIG. 6a1 is a side view of the hinge of the invention, in the position to maintain the vehicle door in the closed position, equivalent to FIG. 3 but reduced in size for clarity: this allows multiple time views of the invention to fit on a single sheet, showing operation.

FIG. 6a2 is a top view of the hinge of the invention at the position and time of FIG. 6a1.

FIG. 6b1 is a side view of the hinge of the invention in the position achieved when the vehicle door is swinging or swung open horizontally on the hinge assembly but not yet rolling on the rider assembly.

FIG. 6b2 is a top view corresponding in time and position to FIG. 6b1.

FIG. 6c1 is a side view of the invention in the position achieved when the vehicle door is fully open, with both swing and roll motions completed.

FIG. 6c2 is a top view corresponding to the position and time of FIG. 6c1.

### INDEX OF THE REFERENCE NUMERALS

Vehicle 100
Frame/chassis 102
Vehicle door 104
Door plate 106
Anchor plate/chassis mounting plate 108
Rail 110
Horizontal motion hinge 112
Rail rider assembly 114
Lower hinge arm 202
Upper hinge arm 204
Hinge pin 206
Middle rail hinge arm 208
Hinge washer/bushing/bearing 210
Hinge pin apertures 212, 214, 216
Rail rider roller support 302
Rail rider roller plate 304
Axle/roller pins 306a, b, c, d
Rollers 308a, b, c, d
Stop 312
Roller race 314
Rail edge 316

### DETAILED DESCRIPTION

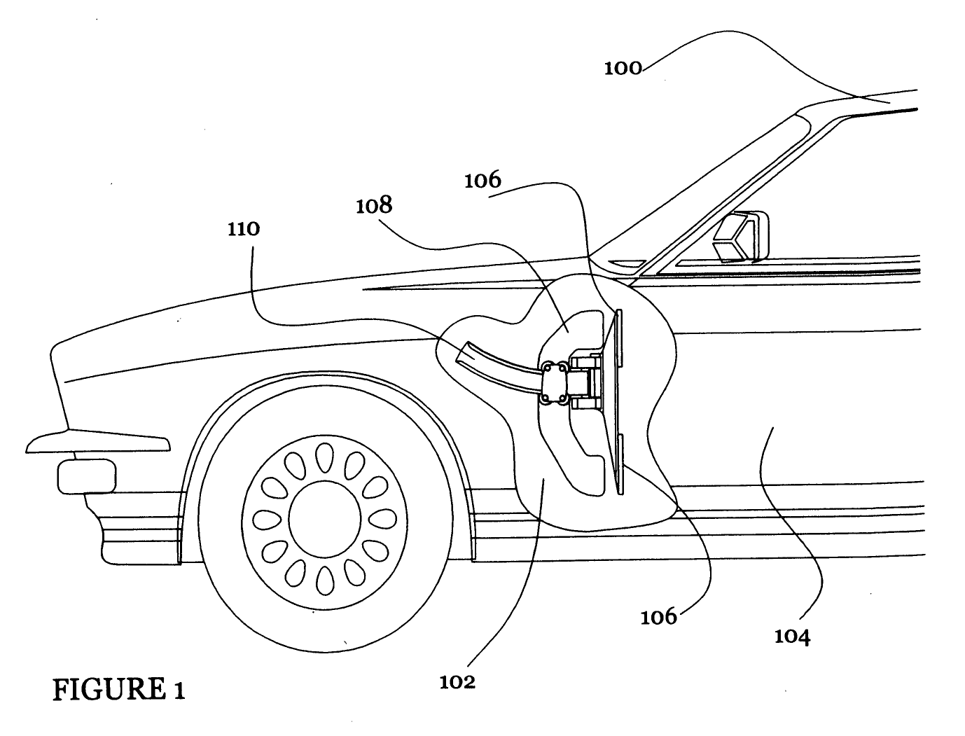

FIG. 1 is a partially transparent side view of a vehicle having the hinge of the invention installed thereon. Vehicle 100 may be of customary design with the hinge of the invention installed at manufacture or as an after market addition or retrofit.

Chassis 102 has an opening or doorway into which vehicle door 104 may fit. Frame/chassis 102 and door 104 are the two parts of the vehicle to which the invention is installed. Door plate 106 attaches to the door 104 while chassis/anchor plate 108 may attach to chassis 102. Both plates may be dimensioned and configured to fit with a particular model of car or may be generic, although specialization is preferable: suitable arrangement of holes and sizes and shapes of the plates may mildly ease the workload of the installer.

Rail 110 may be seen projecting from the device. In embodiments of the invention, the rail may extend through internal apertures judiciously provided in the fender of the vehicle, as needed.

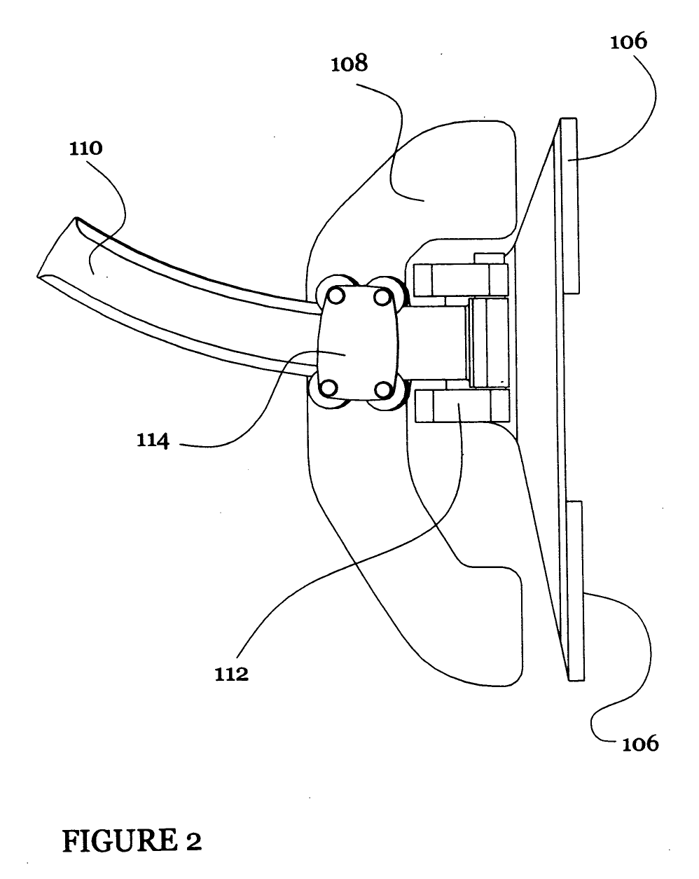

FIG. 2 is a side view of the hinge of the invention, in the position to maintain the vehicle door in the closed position. In this preferred embodiment and best mode contemplated for carrying out the invention, horizontal motion hinge 112 may function to allow the door to clear the vehicle frame in a traditional manner before the rail 110 rides out from the rider assembly 114, allowing rail 110 to move and swing (both rotate and translate) the door 104 upwards to clear the doorway.

“Relative motion” and “mutual motion” of the rail rider assembly 114 and the rail 110 are terms defined herein to refer to the motion of the rail as it passes between the rollers of the chassis plate, regardless of whether the rail rider assembly 114 is viewed as rolling/moving along the rail 110 or whether the rail 110 is viewed as sliding between the rollers. (Note that in an absolute sense, the chassis anchor plate 108 and the rail rider assembly 114 sit still with the vehicle while the rail 110 and the door 104 move.)

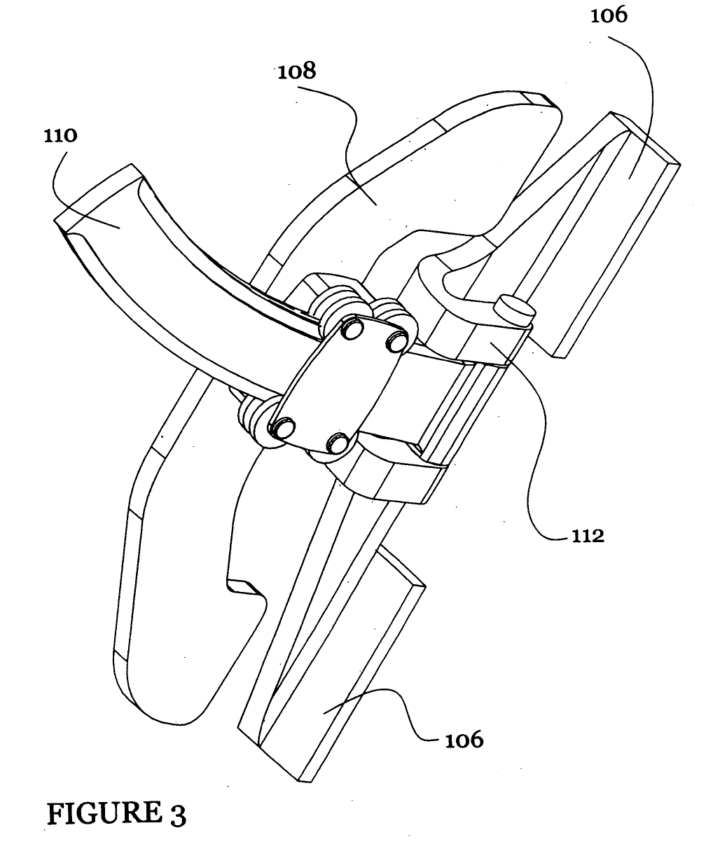

FIG. 3 is an elevational perspective view of the hinge of the invention, in the position to maintain the vehicle door in the closed position. It may be seen that the rollers are physically engaged to the rail at its edge. The roller races match the roller bearing surfaces (the “wheels” of the rollers) while the edge itself projects up in between the roller bearing surfaces, thus preventing relative motion of the rail and rollers in any direction except for mutual motion of the rollers along the rail (in an absolute sense, motion of the rail between the rollers). The rail may not fall from between the rollers as it is trapped between opposing sets of rollers mounted upon the support, while the use of two pairs of rollers also prevents angular motion of the rail relative to the chassis plate.

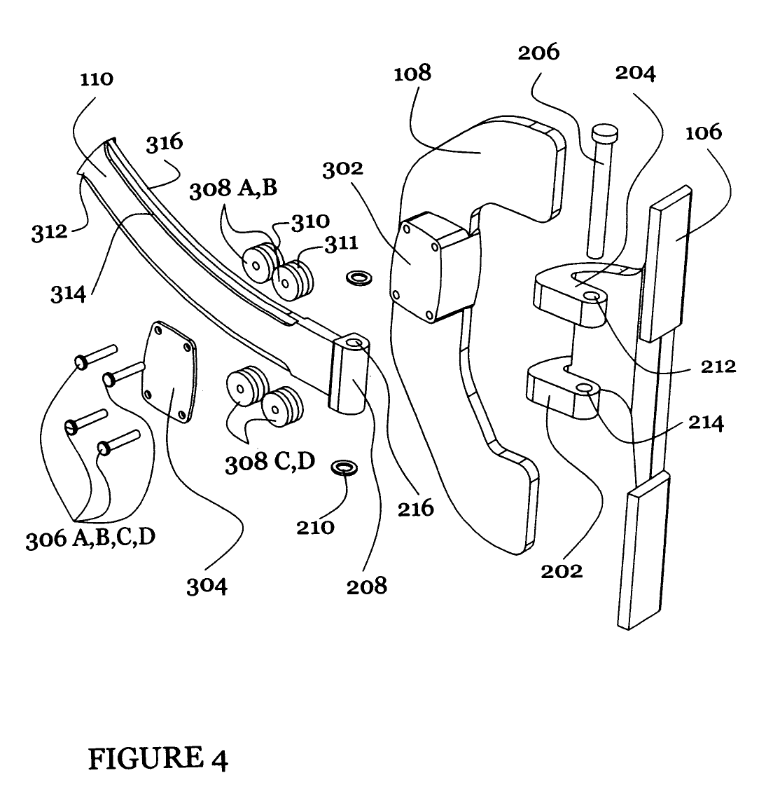

FIG. 4 is an exploded view in elevation and perspective of the parts of the invention. Lower hinge arm 202 and upper hinge arm 204 have middle rail hinge arm 208, and all three arms have apertures 212, 214 or 216 passing therethrough, with hinge pin 206 passing through the apertures so as to allow rotational motion of the hinge (which middle hinge arm 208 is attached to or integral with: the hinge mechanism may be one end of the rail), or more accurately, to allow rotational motion of the door plate 106 and door 104 in respect to the rail 110. Note that in alternative embodiments, the middle arm might be the arm on the hinge while the upper and lower hinge arms might be the arms on the rail.

Hinge washer/bushing/bearing 210 may be used to assist rotation of the hinge mechanism.

The next major assembly is the “truck” or rider through which the rail 110 moves. Rail rider roller support 302 is important in dimension and configuration as it allows the rail to run free of the chassis plate itself and any frame or vehicle structures which must be avoided. Rider roller support 302 may be angled or straight in reference to the anchor plate, as an aspect of the importance of the configuration of the rider roller support 302 in allowing the rail a free run.

Rail rider roller plate 304 helps stabilize and secure axle pins 306a, b, c, d which function as both mounts and axles for rollers 308a, b, c, d. The four rollers 308 may have roller bearing surfaces 310 which project to a greater distance from the axle pins 306 and which may bear the weight of the rail 110 during use, as well as having trench 311 into which rail edge 316 may project, thus efficiently trapping the rail in place and limiting it to a single degree of freedom. Note that another bearing surface of the rollers may be present within the trench 311, on which surface the exact edge of the rail 316 may ride, thus having an alternative bearing surface combination or a third supplemental bearing surface. In embodiments, any combination of such load bearing surfaces may be used.

Stop 312 terminates roller race 314, in which the rollers run, so that the rail may not slide entirely out of the rider roller assembly during usage. (Alternatively, the mutual motion may be described as the stop 312 preventing the rollers 308 from leaving the end of the rail 110).

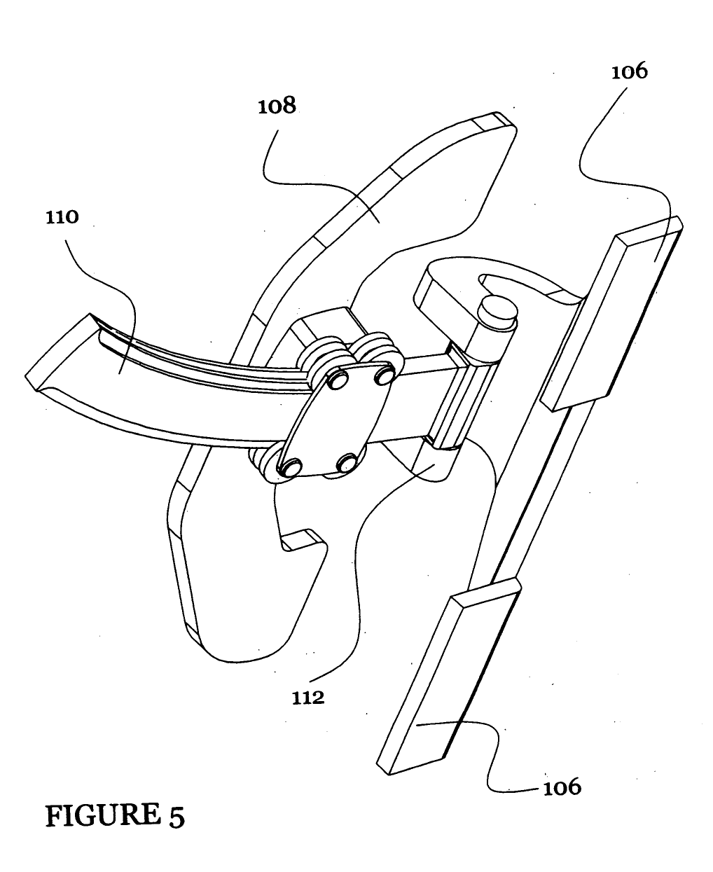

FIG. 5 is an elevational perspective view of the hinge of the invention, in the position achieved when the vehicle door is swinging/swung open horizontally but not yet rolling vertically. Door mounting plate 106 has now turned by an angle which may be quite small or quite large but which angle is sufficient to allow door 104 to clear the vehicle frame. This angle may be the normal car door angle of less than 90 degrees, typically 30 to 70 degrees, or it may be equal to or greater than 90 degrees, even much greater than 90 degrees. In use, this position corresponds to a user swinging the door open but not yet raising it. If the angle is small enough, the door 104 may still block entrance/degress from the vehicle, while if the angle is large enough, the door may allow entrance/egress without ever being moved vertically. In alternative embodiments, the door may come to a first open position close to the vehicle and blocking the doorway which position allows a user inside to easily move the door upwards, and yet the door may also have a second position further open in the horizontal plane which allows use of the doorway without any vertical motion, so that users may select their mode of entry and exit. This can be obtained by use of proper detents and stops on the hinge surfaces.

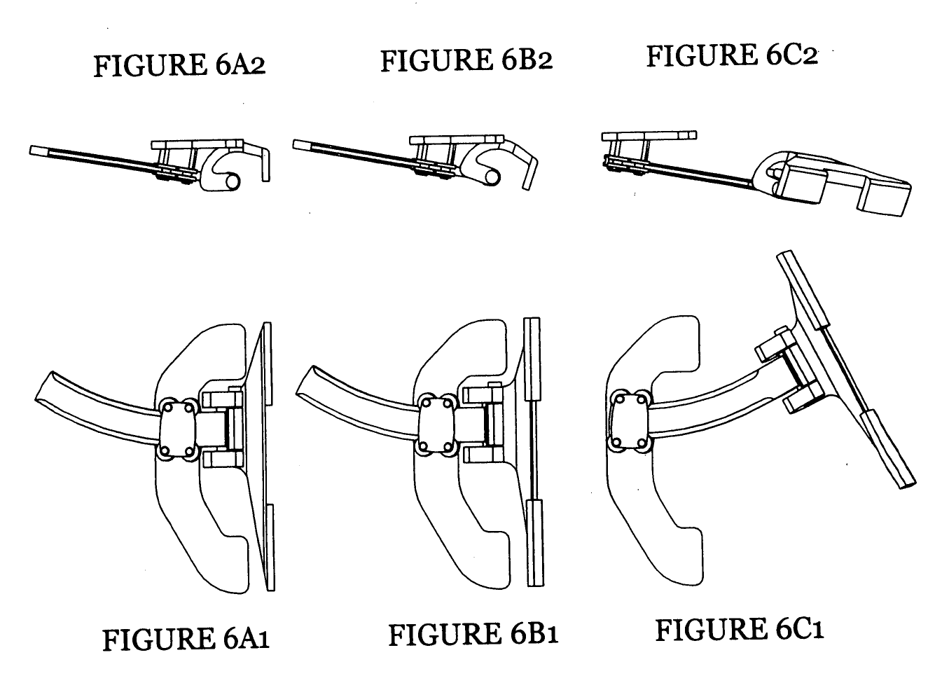

FIG. 6a1 is a side view of the hinge of the invention, in the position to maintain the vehicle door in the closed position, equivalent to FIG. 3 but reduced in size for clarity: this allows multiple time views of the invention to fit on a single sheet, showing operation. FIGS. 6a, 6b and 6c combine to form a sequence showing the motion of the hinge in use. FIG. 6a2 is a top view of the hinge of the invention at the position and time of FIG. 6a1.

This position is the “door close” position.

FIG. 6b1 is a side view of the hinge of the invention in the position achieved when the vehicle door is swinging or swung open horizontally on the hinge assembly but not yet rolling on the rider assembly, and FIG. 6b2 is a top view corresponding in time and position to FIG. 6b1.

The door (as in FIG. 5) has been swung open horizontally about an axis of rotation located at the hinge, the horizontal plane of motion (the first plane of motion) allowing the door to clear the vehicle frame. This angle may be the normal car door angle of less than 90 degrees, typically 30 to 70 degrees, or it may be equal to or greater than 90 degrees, even much greater than 90 degrees.

FIG. 6c1 is a side view of the invention in the position achieved when the vehicle door is fully vertically open, with both swing and roll motions completed. FIG. 6c2 is a top view corresponding to the position and time of FIG. 6c1: the door has swung horizontally and, “twisted” (rotated about a point outside the vehicle, door, frame, or hinge) in a vertical plane of motion upwards. Note that after the radius of curvature of the rail is determined, the location of the point in space about which the door rotates becomes known, even if this point is not a physical point which is part of the vehicle.

Careful selection of this radius of curvature allows the hinge of the invention to be adapted to a wide variety of vehicle frames and structures, yet without substantial alteration of the vehicle structure other than mounting the chassis plate, door plate, and providing a space for the rail to run on the rollers. Radius of curvatures (defined as the distance from the rail edge to the point about which rotation occurs) may be from 0 inch up to any number of inches are contemplated. Note that a straight rail (infinite radius of curvature) may be used as the rail may be angled so that the entire door simply moves upward in translation without any rotation. However, it is believed to be more effective to have fairly small radii of curvature (72 inches down to 1 inch) as this allows large motions of the door in rotation with relatively small motions in translation.

Note that one rail may have multiple radii of curvature, that is, it may conform to two different curves, straight lines, or otherwise have more than one shape. This would allow the door to rotate about a first point during a first section of the motion of the rail and yet rotate about a second point during a section of the motion of the rail, thus resulting in quite complex motions of the door in the second, vertical, plane of motion.

The length of the rail may be optimized for vehicle structures and desirable amount of rotation relative to translation. In particular rail lengths from 2 inches up to 36 inches are contemplated, though smaller vehicles or larger may have rail lengths outside these ranges. As shown in the figures, such as FIG. 2, the rail length is a multiple of the rail width and depth, with width and depth being primarily selected for strength while length will, as noted, depend upon vehicle structures and the desired motion of the door in the vertical plane.

One end of the rail may be the hinge while the other end may have stops, as pictured in all the diagrams, however, the stops or hinge may be located at places other than the first and second ends shown.

The method of opening the door by the invention consists of two steps:
1) swinging of the door about the hinge pin, that is, a rotation of the door in a first horizontal plane about the axis defined by the hinge pin;
2) translation of the door in a second vertical plane as the rail slides through the rollers, this translation may induce a rotation of the door in the vertical plane, the rotation occurring about a point actually located outside the rail, hinge or door and the degree of rotation defined precisely by the shape/curvature of the rail.

The disclosure is provided to render practicable the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

What is claimed is:

1. A vehicle door hinge for a vehicle door and body, the hinge comprising:
an anchor plate secured to such vehicle, the anchor plate having a support thereon, the support having a first roller thereon;
a door plate secured to such vehicle door;
a hinge secured to such door plate, the hinge having a rail having a length projecting therefrom, thereby allowing the door plate to rotate in a first plane of motion relative to the rail;
the rail physically engaged to the first roller and the rail supported by the first roller.

2. The vehicle door hinge of claim 1, further comprising:
a first rail edge and a first roller race disposed along the length parallel to the first rail edge, the first roller engaged with the first rail edge and first roller race.

3. The vehicle door hinge of claim 2, further comprising:
a second rail edge and a second roller race disposed along the length parallel to the first rail edge;
a second roller on the support, the second roller physically engaged with the second rail edge and second roller race, thereby allowing mutual motion of the rail and rollers along the length and preventing mutual motion in any other dimension.

4. The vehicle door hinge of claim 3, further comprising:
a stop located at a first end of the rail, the stop terminating the roller race, thereby preventing mutual motion of the rail and rollers beyond the first end of the rail.

5. The vehicle door hinge of claim 3, further comprising:
third and fourth rollers on the support, the third and fourth rollers physically engaged with the respective first and second rail edges and first and second roller races, thereby preventing angular motions of the rail relative to the support.

6. The vehicle door hinge of claim 1, wherein the support further comprises:
a first axle pin passing through an aperture in the roller and secured to the support, the roller mounted upon the support by means of the axle pin.

7. The vehicle door hinge of claim 6, wherein the support further comprises:
a roller stop mounted upon the first axle pin, the roller stop larger than the aperture thereby preventing the roller from leaving the axle pin.

8. The vehicle door hinge of claim 1, wherein the hinge further comprises:
upper and lower hinge arms having apertures therethrough;
a middle rail hinge arm on a second end of the rail, the middle rail hinge arm also having an aperture therethrough;
a hinge pin passing through the apertures in the upper, middle and lower arms.

9. The vehicle door hinge of claim 1, wherein the rail is curved.

10. The vehicle door hinge of claim 9, wherein the curvature of the rail causes rotation of the door when the roller and rail move relative to one another, the rotation occurring in a second plane of motion.

11. The vehicle door hinge of claim 10, wherein the curvature of the rail has a radius of curvature and wherein the radius of curvature is such that the axis of rotation of the door in the second plane of motion occurs about a point located outside of the vehicle, frame and door.

12. The vehicle door hinge of claim 1, wherein the support may be angled in reference to the anchor plate.

13. The vehicle door hinge of claim 1, wherein the rotation in the first plane of motion is greater than or equal to 90 degrees.

14. A method of opening a vehicle door in a vehicle door frame, the method comprising the steps of:
a) rotating the vehicle door in a horizontal plane of motion until the vehicle door substantially clears the vehicle frame;
b) raising the vehicle door in a vertical plane of motion defined by the mutual motion of a rail mounted on the vehicle door and at least one roller mounted on the vehicle frame.

15. The method of opening a vehicle door of claim 14, wherein the rail is curved.

16. The method of opening a vehicle door of claim 15, wherein the curvature of the rail causes rotation of the door when the roller and rail move relative to one another, the rotation occurring in a second plane of motion.

17. The method of opening a vehicle door of claim 16, wherein the curvature of the rail has a radius of curvature and wherein the radius of curvature is such that the axis of rotation of the door in the second plane of motion occurs about a point located outside of the vehicle, frame and door.
